(19) United States
(12) Patent Application Publication
(10) Pub. No.: US 2024/0272596 A1
(43) Pub. Date: Aug. 15, 2024

(54) ELECTRONIC DEVICE AND CONTROL METHOD THEREFOR

(71) Applicant: SAMSUNG ELECTRONICS CO., LTD., Suwon-si (KR)

(72) Inventors: Minhee PARK, Suwon-si (KR); Donghyun KANG, Suwon-si (KR); Seongjin KIM, Suwon-si (KR); Taehun KIM, Suwon-si (KR); Sangmook LIM, Suwon-si (KR)

(21) Appl. No.: 18/643,635

(22) Filed: Apr. 23, 2024

Related U.S. Application Data
(63) Continuation of application No. PCT/KR2022/017437, filed on Nov. 8, 2022.

(30) Foreign Application Priority Data
Nov. 12, 2021 (KR) 10-2021-0155541

(51) Int. Cl. G05B 15/02; H04N 21/442

(52) U.S. Cl. CPC G05B 15/02; H04N 21/44204

(57) ABSTRACT

An electronic apparatus includes: at least one processor, comprising processing circuitry, individually and/or collectively, configured to: acquire usage behavior data about a plurality of applications executed in a plurality of external devices and a plurality of functions provided by each external device, from the plurality of external devices through a communication circuit; acquire relevant information indicating one or more functions performed within a period range based on an execution point in time of the application among the plurality of functions, based on the acquired usage behavior data; and perform a recommended operation of the one or more functions corresponding to an application executed in the external device, based on the acquired relevant information.

### CROSS-REFERENCE TO RELATED APPLICATIONS

This application is a continuation of International Application No. PCT/KR2022/017437 designating the United States, filed on Nov. 8, 2022, in the Korean Intellectual Property Receiving Office and claiming priority to Korean Patent Application No. 10-2021-0155541, filed on Nov. 12, 2021, in the Korean Intellectual Property Office, the disclosures of each of which are incorporated by reference herein in their entireties.

### BACKGROUND

### Field

The disclosure relates an electronic apparatus, which includes a storage where a file is stored and a memory where a page corresponding to the file is loaded for processing, and a method of controlling the same, and for example, to an electronic apparatus, which can make the capacity of a memory available, and a method of controlling the same.

### Description of Related Art

To compute and process predetermined information in accordance with certain processes, an electronic apparatus basically includes a central processing unit (CPU), a chipset, a memory, and the like electronic components for the computation. Such an electronic apparatus may be variously classified in accordance with what information will be processed and what it is used for. For example, the electronic apparatus is classified into an information processing apparatus such as a personal computer (PC), a server or the like for processing general information; an image processing apparatus for processing image data; an audio apparatus for audio process; home appliances for miscellaneous household chores; etc. The image processing apparatus may be implemented as a display device that displays an image based on processed image data on its own display panel. Various types of such electronic apparatuses are communicatively connected to each other, and serve either as a server or host that provides a predetermined service, or a client that receives the service.

A user controls various functions provided by a TV, a mobile device or the like display device as desired when executing an application (app) or the like content through the display device, so that the content can run to suit the user's taste. For example, it will be assumed that the user wants to view a streaming image provided through a server when the display device is in a first image quality mode for a broadcast image provided through public broadcasting or cable broadcasting is set among a plurality of image quality modes. In this case, to view the streaming image with more suitable image quality, the user needs to switch the display device over to a second image quality mode for the streaming image among the plurality of image quality modes. However, if the user does not know about such a function, the user will view the streaming image without switching over to the second mode.

Content to be executed on the display device is newly discovered and recommended, but most of functions provided by the display device to execute the content are not newly added. After purchasing the display device, a user often uses only restricted functions frequently used through a few searches. Therefore, even though there are useful functions supported by the display device in relation to the execution of the content, a user may not use those functions.

Accordingly, there may be a need for an electronic apparatus that identifies a display device′ functions useful for the execution of predetermined content a user wants to execute through the display device, and provides the identified functions to the user.

### SUMMARY

According to an example embodiment of the disclosure, an electronic apparatus includes: a communication circuit; and at least one processor, comprising processing circuitry, individually and/or collectively configured to: acquire usage behavior data about a plurality of applications executed in a plurality of external devices and a plurality of functions provided by each external device, from the plurality of external devices through the communication circuit, acquire relevant information indicating one or more functions performed within a period range based on an execution point in time of the application among the plurality of functions, based on the acquired usage behavior data, and perform a recommended operation of the one or more functions corresponding to an application executed in the external device, based on the acquired relevant information.

Further, at least one processor, individually and/or collectively, may be configured to: identify a function having a high usage frequency among the one or more functions indicated by the relevant information, and perform the recommended operation of the function, identified as having the high usage frequency, for the external device designated.

Further, at least one processor, individually and/or collectively, may be configured to: perform the recommended operation of a function, which does not overlap with one or more functions indicated as having been used based on the usage behavior data of the designated external device, among the functions identified as having the high usage frequency.

Further, at least one processor, individually and/or collectively, may be configured to: identify a plurality of usage patterns of each application based on the acquired usage behavior data, and identify a function, corresponding to a usage pattern having the highest usage frequency among the plurality of identified usage patterns, as the at least one function to perform the recommended operation.

Further, at least one processor, individually and/or collectively, may be configured to: identify a function having a high usage frequency, from the usage behavior data indicating the usage pattern having the highest usage frequency, as the at least one function to perform the recommended operation.

Further, the plurality of usage patterns may include: a pattern of executing another application within the period range until the application designated for the recommended operation is executed.

Further, at least one processor, individually and/or collectively, may be configured to: identify a usage pattern group including one or more usage patterns having similarities greater than a specified level to the usage pattern having the highest usage frequency among the plurality of identified usage patterns, and identify functions corresponding to the usage patterns in the identified usage pattern group, as the at least one function to perform the recommended operation.

Further, at least one processor, individually and/or collectively, may be configured to: identify a function having a usage frequency greater than a specified threshold in the usage behavior data indicating each usage pattern in the usage pattern, as the at least one function to perform the recommended operation.

Further, at least one processor, individually and/or collectively, may be configured to: identify the period range based on a period ranging from a first point in time, which is a specified point in time before the designated application is executed, to a second point in time based on the designated application being terminated.

According to an example embodiment of the disclosure, a method of controlling an electronic apparatus includes: acquiring usage behavior data about a plurality of applications executed in a plurality of external devices and a plurality of functions provided by each external device, from the plurality of external devices; acquiring relevant information indicating one or more functions performed within a period range based on an execution point in time of the application among the plurality of functions, based on the acquired usage behavior data; and performing a recommended operation of the one or more functions corresponding to an application executed in the external device, based on the acquired relevant information.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating example electronic apparatus and external devices according to various embodiments;

FIG. 2 is a block diagram illustrating an example configuration of an electronic apparatus and an external device according to various embodiments;

FIG. 3 is a flowchart illustrating an example method of controlling an electronic apparatus according to various embodiments;

FIG. 4 is a diagram illustrating an example user interface (UI) that asks a user's permission to collect usage behavior data from an external device according to various embodiments;

FIG. 5 is a timing diagram illustrating an example method of processing data collected from external devices to be processible in an electronic apparatus according to various embodiments;

FIG. 6 is a diagram illustrating example unit data sorted for each session according to usage patterns of a plurality of applications according to various embodiments;

FIG. 7 is a diagram illustrating results from comparing similarities between a plurality of sessions according to various embodiments;

FIG. 8 is a diagram illustrating similarities between a plurality of sessions according to various embodiments;

FIG. 9 is a diagram illustrating a principle that an electronic apparatus guides recommended functions to a specific external device according to various embodiments;

FIG. 10 is a diagram illustrating an example UI through which an external device guides recommended functions according to various embodiments; and

FIG. 11 is a flowchart illustrating an example method of an electronic apparatus identifying recommended functions according to various embodiments.

### DETAILED DESCRIPTION

Below, various example embodiments will be described in greater detail with reference to accompanying drawings. Further, the various embodiments described with reference to the accompanying drawings are not exclusive to each other unless otherwise mentioned, and various embodiments may be selectively combined within one apparatus. The combination of these plural embodiments may be discretionally selected and applied to realize the disclosed concepts by a person having an ordinary skill in the art.

In the disclosure, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the disclosure.

Further, a term “at least one” among a plurality of elements in the disclosure represents not only all the elements but also each one of the elements, which excludes the other elements or all combinations of the elements.

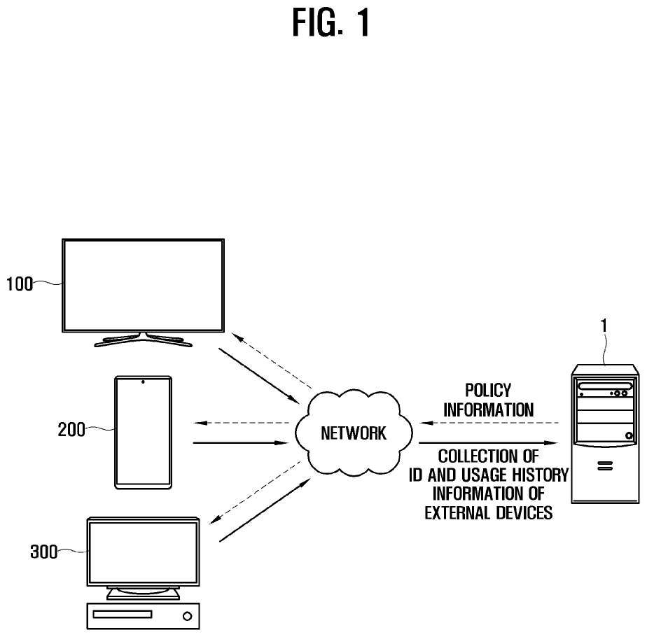

FIG. 1 is a diagram illustrating an example electronic apparatus and external devices according to various embodiments.

As shown in FIG. 1, an electronic apparatus 1 according to an embodiment of the disclosure may for example be implemented as a server, and provided to communicate with a plurality of external devices 100, 200, and 300 through a network. However, the electronic apparatus 1 is not necessarily limited to the server but may be implemented by various types of apparatuses. For example, the electronic apparatus 1 may be a host apparatus communicatively connected to various types of external devices 100, 200, and 300. The electronic apparatus 1 and the external devices 100, 200, and 300 may be connected by various methods such as one-to-many connection based on a wide area network, a local area network, a cable.

Further, this example is applied when one electronic apparatus 1 performs relevant operations, but this is merely an example. This example may also be applied even when a plurality of electronic apparatuses 1 operate in conjunction with one another. In this case, the relevant operations may be shared and performed among the plurality of electronic apparatuses 1 communicatively connected to one another.

The external devices 100, 200, and 300 may be implemented by various kinds of apparatuses, for example, a personal computer (PC), a server or the like information processing apparatus; a television (TV), a monitor, a digital signage, an electronic blackboard, an electronic frame, or the like stationary display device; a smartphone, a tablet device, a portable multimedia player or the like mobile device; a set-top box, an optical media player or the like image processing apparatus; a refrigerator, a washing machine, a clothing manager, an air conditioner or the like home appliances; a gateway, a hub, and a slave apparatus for establishing the Internet of things (IOT) environment; or a wearable device for a human. In an embodiment, three external devices 100, 200, and 300 are connected to the electronic apparatus 1. However, there are no limits to a practical number of external devices 100, 200, and 300 communicatively connected to the electronic apparatus 1.

The electronic apparatus 1 is provided to identify the plurality of external devices 100, 200, and 300 interactively. As an example of identifying the external devices 100, 200, and 300, the electronic apparatus 1 may identify each device identification (ID) of the external devices 100, 200, and 300, or the ID of users who use the external devices 100, 200, and 300. The ID of the external devices 100, 200, and 300 may be given to the external devices 100, 200, and 300 in advance or input to the external devices 100, 200, and 300 by a user, and then transmitted from the external devices 100, 200, and 300 to the electronic apparatus 1. The electronic apparatus 1 may arbitrarily assign the ID to each of the external devices 100, 200, and 300 for communication.

In addition to managing each ID of the external devices 100, 200, and 300, the electronic apparatus 1 stores data about usage behavior of users who have used the external devices 100, 200, and 300 from those external devices 100, 200, and 300. For example, each of the external devices 100, 200, and 300 accumulates a usage history of various pieces of content a user has viewed, executed or used, and a usage history of various functions those external devices 100, 200, and 300 provide. The content may include various applications, programs, data, etc. executed on the external devices 100, 200, and 300. The electronic apparatus 1 acquires usage behavior data based on the usage histories of the external devices 100, 200, and 300, and stores and manages the acquired usage behavior data to correspond to each ID of the external devices 100, 200, and 300. In this case, the electronic apparatus 1 may acquire the usage behavior data from all connectable external devices 100, 200, and 300, or may acquire the usage behavior data of the external devices 100, 200, and 300 only when users of those external devices 100, 200, and 300 permit the electronic apparatus 1 to collect the usage behavior data of the external devices 100, 200, and 300.

Although the electronic apparatus 1 can collect the usage behavior data about all the connectable external devices 100, 200, and 300 from those external devices 100, 200, and 300, the electronic apparatus 1 may acquire the usage behavior data from only the external devices 100, 200, and 300 permitted by their users among the connectable external devices 100, 200, and 300. In this regard, details will be described below.

Below, the configuration of the electronic apparatus 1 will be described.

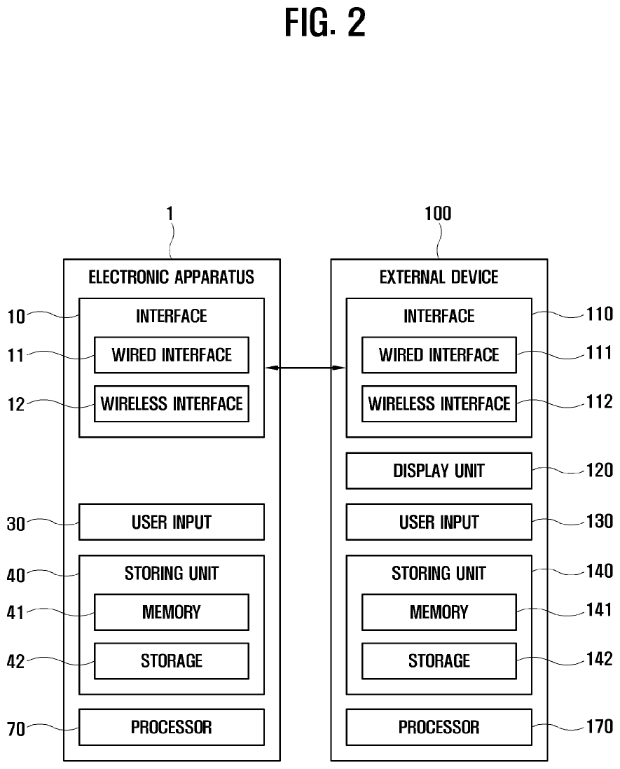

FIG. 2 is a block diagram illustrating an example configuration of an electronic apparatus and an external device according to various embodiments.

As shown in FIG. 2, the electronic apparatus 1 and the external device 100 include various hardware elements for operations. In this example, the external device 100 is named for convenience to be distinguished from the electronic apparatus 1 according to an embodiment, and may be implemented by various types of devices as described above. In this example, a case where that the external device 100 is a display device will be described.

The electronic apparatus 1 may include an interface (e.g., including various circuitry) 10. The interface 10 includes an interface circuit through which the electronic apparatus 1 performs communication with the external device 100 and transmits and receives data. The interface 10 may include at least one of one or more wired interfaces 11 for wired communication, or one or more wireless interface 12 for wireless communication according to connection types.

The wired interface 11 may include a connector or port to which a cable of previously defined transmission standards is connected. For example, the wired interface 11 includes a port connecting with a terrestrial or satellite antenna to receive a broadcast signal or connecting with a cable for cable broadcasting. Further, the wired interface 11 include ports to which cables of various wired transmission standards such as high-definition multimedia interface (HDMI), DisplayPort (DP), digital video interactive (DVI), component, composite, S-video, thunderbolt, and the like to connect with various image processing apparatuses. Further, the wired interface 11 includes a port of universal serial bus (USB) standards to connect with a USB device. Further, the wired interface 11 includes an optical port to which an optical cable is connected. Further, the wired interface 11 includes an audio input port to which an external microphone is connected, and an audio output port to which a headset, an earphone, a loudspeaker etc. is connected. Further, the wired interface 11 includes an Ethernet port connected to a gateway, a router, a hub, etc. for connection with a wide area network (WAN).

The wireless interface 12 includes an interactive communication circuit including at least one of elements such as a communication module, a communication chip, etc. corresponding to various kinds of wireless communication protocols. For example, the wireless interface 12 includes a Wi-Fi communication chip for wireless communication with the access point (AP) based on Wi-Fi; a communication chip for wireless communication based on Bluetooth, Zigbee, Z-Wave, Wireless HD, wireless gigabits (WiGig), near field communication (NFC), etc.; an infrared (IR) module for IR communication; a mobile communication chip for mobile communication with a mobile device 200; etc.

The electronic apparatus 1 may include a user input (e.g., including input circuitry) 30. The user input 30 includes a circuit related to various kinds of user input interfaces to be controlled by a user to thereby receive a user input. The user input 30 may be variously configured according to the kinds of electronic apparatuses 1, and may for example include a mechanical or electronic button of the electronic apparatus 1; various kinds of sensors; a touch pad; a touch screen; an external input device, such as a remote controller, a keyboard, and a mouse, separated from the electronic apparatus 1 and connected through the interface 10; etc.

The electronic apparatus 1 may include a storing unit (e.g., including a memory) 40. The storing unit 40 is configured to store digitalized data. The storing unit 40 includes one or more volatile memories 41 in which data to be processed by a processor 70 is loaded and data is retained only when power is supplied, and the memory 41 includes a buffer, a RAM, etc. Further, the storing unit 40 includes one or more non-volatile storages 42 in which data is retained regardless of whether power is supplied or not. The storage 42 includes a flash memory, a hard disc driver (HDD), a solid-state drive (SSD), a read only memory (ROM), etc.

The electronic apparatus 1 may include at least one processor (e.g., including processing circuitry) 70. The processor 70 may include one or more hardware processors implemented as a central processing unit (CPU), a chipset, a buffer, a circuit, etc. which are mounted on a printed circuit board (PCB). The processor 70 may be designed as a system on chip (SoC). The processor 70 performs control for the operations of the electronic apparatus 1, and processes various pieces of information or data. The processor 70 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Meanwhile, the external device 100 includes an interface (e.g., including various circuitry) 110 including at least one of a wired interface 111 or a wireless interface 112, a user input (e.g., including input circuitry) 130, and a storing unit (e.g., including a memory) 140 including a memory 141 and a storage 142. The foregoing elements of the external device 100 perform basically similar functions to the elements of the same name in the electronic apparatus 1, and thus repetitive descriptions thereof will be avoided.

When the external device 100 is implemented as a display device, the external device 10 may include a display unit (e.g., including a display) 120. The display unit 120 may form a screen to display an image based on an image signal processed by a processor 170. The display unit 120 includes a display panel, and various design methods may be applied to the structure of the display panel. For example, the display unit 120 may include a display panel that has a structure required to receive light like liquid crystal, and a backlight that provides light to the display panel. Alternatively, the display unit 120 may have a display panel that has a structure of emitting light in itself like an organic light emitting diode (OLED). The display unit 120 may have a structure in which a plurality of micro-LED modules are combined in the form of tiles to form a large screen.

The external device 100 may include a loudspeaker 150. When the processor 170 reproduces predetermined content, the loudspeaker (not shown) outputs a sound of that content. The loudspeaker may be provided in the external device 100, or may be provided as a separate device, such as a sound bar, separated from the external device 100. When the loudspeaker is provided as the separate device, the loudspeaker is connected to the interface 110, and an audio signal is transmitted to the loudspeaker via the interface 110.

The external device 100 may include the processor 170. The processor 170 include one or more hardware processors implemented as a CPU, a chipset, a buffer, a circuit, etc. which are mounted onto a PCB. Alternatively, the processor 170 may be designed as a SoC. The processor 170 includes modules corresponding to various processes of a demultiplexer, a decoder, a scaler, an audio digital signal processor (DSP), an amplifier, etc. to display an image based on image content. Here, some or all of such modules may be achieved by the SoC. For example, the demultiplexer, the decoder, the scaler, and the like module related to an image process may be achieved as an image processing SoC, and the audio DSP may be achieved as a chipset separated from the SoC. The processor 170 reproduces predetermined content so that an image of that content can be displayed on the display unit 120 and a sound of that content can be output through the loudspeaker. The processor 170 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Below, a method of identifying functions useful for the execution of predetermined content, e.g., an application and providing the identified functions to a user of the external device 100 when the electronic apparatus 1 executes that application in the external device 100 will be described.

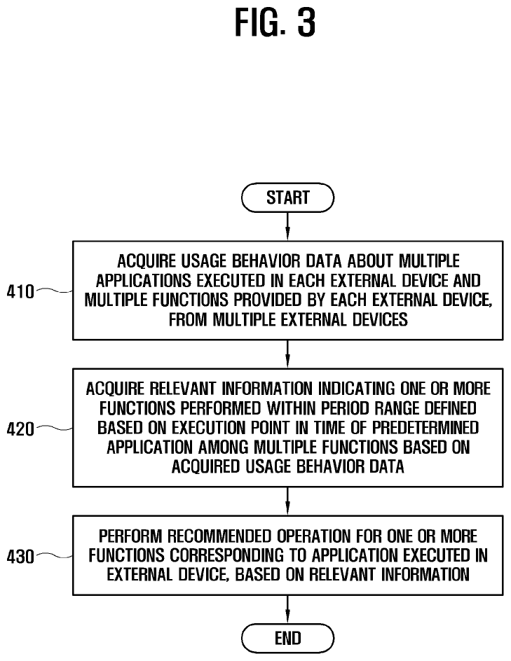

FIG. 3 is a flowchart illustrating an example method of controlling an electronic apparatus according to various embodiments.

As shown in FIGS. 1, 2 and 3, the following operations may be performed by the processor 70 of the electronic apparatus 1.

At operation 410 the electronic apparatus 1 acquires the usage behavior data about a plurality of applications executed in each external device 100 and a plurality of functions provided by each external device 100 from a plurality of user external devices 100.

At operation 420 the electronic apparatus 1 acquires relevant information indicating one or more functions performed within a period range defined based on an execution point in time of a predetermined application among a plurality of functions, based on the acquired usage behavior data. For example, the electronic apparatus 1 may acquire the relevant information based on the acquired usage behavior data, or may receive the relevant information from other devices. Details of the relevant information will be described later.

At operation 430 the electronic apparatus 1 performs a recommended operation for one or more functions corresponding to an application executed in the external device 100, based on the relevant information. For example, when an application is executed in the external device 100, the electronic apparatus 1 may display a pop-up message for guiding the identified functions on a screen where the application is running.

In this way, when a predetermined application is executed in the external device 100, the electronic apparatus 1 may recommend the functions useful for the execution of the application to the user of that external device 100.

Meanwhile, the processor 70 of the electronic apparatus 1 may use at least one of machine learning, neural network, or deep learning algorithm as a rule based or artificial intelligence (AI) algorithm for performing at least one of data analysis, processing, and result information generation to implement the foregoing operations of identifying one or more functions performed within the period range defined based on the execution point in time of a predetermined application among a plurality of functions, based on the usage behavior data of the external device 100.

For example, the processor 70 of the electronic apparatus 1 may function as a learner and a recognizer. The learner may perform a function of generating the trained neural network, and the recognizer may perform a function of recognizing (or inferring, predicting, estimating and identifying) the data based on the trained neural network. The learner may generate or update the neural network. The learner may acquire learning data to generate the neural network. For example, the learner may acquire the learning data from the storage of the electronic apparatus 1 or from the outside. The learning data may be data used for training the neural network, and the data subjected to the foregoing operations may be used as the learning data for training the neural network.

Before training the neural network based on the learning data, the learner may perform a preprocessing operation with regard to the acquired learning data or select data to be used in the training among a plurality of pieces of the learning data. For example, the learner may process the learning data to have a preset format, apply filtering to the learning data, or process the learning data to be suitable for the training by adding/removing noise to/from the learning data. The learner may use the preprocessed learning data for generating the neural network which is set to perform the operations.

The learned neural network may include a plurality of neural networks (or layers). The nodes of the plurality of neural networks have weighted values, and the plurality of neural networks may be connected to one another so that an output value of a certain neural network can be used as an input value of another neural network. As an example of the neural network, there are a convolutional neural network (CNN), a deep neural network (DNN), a recurrent neural network (RNN), a restricted Boltzmann machine (RBM), a deep belief network (DBN), a bidirectional recurrent deep neural network (BRDNN) and deep Q-networks.

Meanwhile, the recognizer may acquire target data to carry out the foregoing operations. The target data may be acquired from the storage of the electronic apparatus 1 or from the outside. The target data may be data targeted to be recognized by the neural network. Before applying the target data to the trained neural network, the recognizer may perform a preprocessing operation with respect to the acquired target data, or select data to be used in recognition among a plurality of pieces of target data. For example, the recognizer may process the target data to have a preset format, apply filtering to the target data, or process the target data into data suitable for recognition by adding/removing noise. The recognizer may acquire an output value output from the neural network by applying the preprocessed target data to the neural network. Further, the recognizer may acquire a stochastic value or a reliability value together with the output value.

Below, a method of collecting usage behavior data from the external device 100 will be described in greater detail.

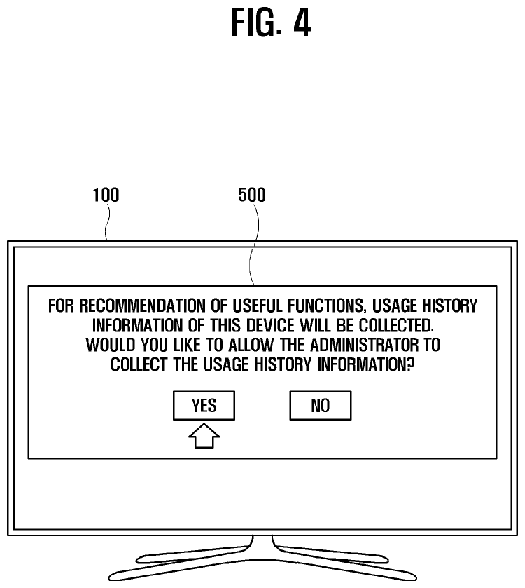

FIG. 4 is a diagram illustrating an example user interface (UI) that asks a user's permission to collect usage behavior data from an external apparatus according to various embodiments.

As shown in FIGS. 1 and 4, the electronic apparatus 1 transmits policy information including guidelines for collecting the usage behavior data from the external devices 100, 200, and 300 to the external devices 100, 200, and 300. The policy information specifies conditions for what kind of usage records will be collected from the external devices 100, 200, and 300. For example, the policy information specifies each model, released year, use-allowed country, etc. of the external devices 100, 200, and 300 targeted for collecting the usage behavior data; a period of time to collect the usage behavior data from the targeted external devices 100, 200, and 300; the types of usage records; etc.

When the external devices 100, 200, and 300 are identified as the targets specified in the policy information received from the electronic apparatus 1, those external devices 100, 200, and 300 may display a UI 500 asking a user's permission to collect the usage behavior data. When the external devices 100, 200, and 300 are identified as not being the targets specified in the policy information, the external devices 100, 200, and 300 do not display the UI 500 and do not collect the usage behavior data.

When a user's permission option is selected through the UI 500, the external devices 100, 200, and 300 collect the usage behavior data as specified in the policy information and transmit the collected usage behavior data to the electronic apparatus 1. The external devices 100, 200, and 300 do not collect the usage behavior data when a user's permission option is not selected through the UI 500.

Below, a method of processing the usage behavior data collected from the external devices 100, 200, and 300 in order to identify the recommended functions will be described in greater detail.

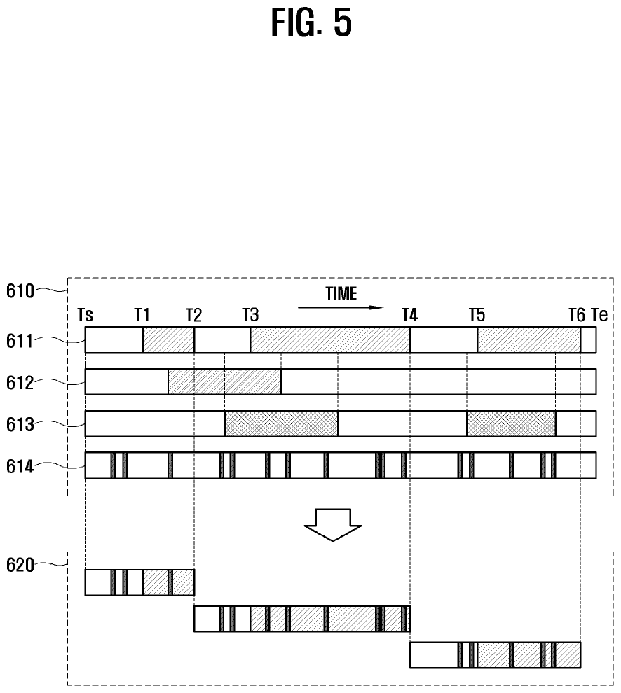

FIG. 5 is a timing diagram illustrating an example method of processing data collected from external devices to be processible in an electronic apparatus according to various embodiments.

As shown in FIGS. 1 and 5, raw data 610, e.g., the usage behavior data about the histories of applications that have been executed for a predetermined period of time and functions performed for those applications may be collected from one of the external devices 100, 200, and 300. In the accompanying drawings, the raw data 610 includes the running periods 611, 612, and 613 of the application within the entire time period, and implementation information 614 about the functions provided by the external devices 100, 200, and 300 at a predetermined point in time of the time period. What history is to be collected from what type of external devices 100, 200, and 300 for what period of time may be specified in the policy information as described above.

In the raw data 610 shown in FIG. 5, the white bar extending from a point in time Ts to a point in time Te indicates the entire time period for which the raw data 610 has been collected, and the periods for which the applications are running or the functions are implemented are illustrated to be visually distinguished from the entire time period. Although the implementation information 614 about the functions in FIG. 5 is not illustrated separately for each function, the implementation information 614 about the function includes execution records for various function.

The electronic apparatus 1 extracts the number of times or the period each application has been used from such a plurality of pieces of raw data 610 acquired from various external devices 100, 200, and 300, and makes a usage table of each application for each user. In the usage table, records on the number of times or the period a certain application has been used by each user are tabulated. Based on the usage table, the electronic apparatus 1 selects a group of users who have used an application a large number of times or for a long period of time (e.g., greater than a threshold value). The electronic apparatus 1 identifies the group of users who have used a designated application a large number of times or for a long period of time, and perform a process for identifying the recommended function based on the raw data 610 acquired from the users who belong to the identified group.

Within the entire period from the start point in time Ts (e.g., when the external device 100, 200 or 300 is turned on) of the raw data 610 to the end point in time Te (e.g., the external device 100, 200 or 300 is turned off), there are running periods of a plurality of applications, e.g., a running period 611 of a first application, a running period 612 of a second application, and a running period 613 of a third application. When a certain application has multiple running periods, a user has terminated that application and then executes that application again.

By processing the raw data 610 with respect to a certain designated application, unit data 620 of the external devices 100, 200, and 300 for that designated application is derived from the raw data 610. The unit data 620 for the designated application corresponds to the relevant information described above in operation 420 of FIG. 3. The electronic apparatus 1 may receive the raw data 610 from the external devices 100, 200, and 300 and process the received raw data 610 into the unit data 620. Alternatively, the external devices 100, 200, and 300 may process the raw data 610 into the unit data 620 and then transmit the unit data 620 to the electronic apparatus 1.

For example, it will be assumed that the raw data 610 is processed with respect to the first application. Within the entire time period of the raw data 610, the first application has three running periods including a first period from T1 to T2, a second period from T3 to T4, and a third period from T5 to T6. Here, three pieces of unit data 620 corresponding to the foregoing three periods are generated.

For example, first unit data of the unit data 620, which corresponds to the first period, includes a history in a period from a predetermined point in time (e.g., Ts) before T1 to T2. The second unit data corresponding to the second period includes a history in a period from a predetermined point in time (e.g., T2) before T3 to T4. The third unit data corresponding to the third period includes a history in a period from a predetermined point in time (e.g., T4) before T5 to T6. In other words, each piece of the unit data 620 refers to a period range defined based on an execution point in time of the first application of interest, which includes a period of time before the execution point in time of the application and a period of time after the execution point in time of the application. Below, the reason why the period of the unit data 620 is set in this way will be described in greater detail.

For example, it will be assumed that a user wants to execute an application in the external device 100, 200 or 300. The user may control the functions related to the image quality, sound quality, performance, etc. provided in the external devices 100, 200, and 300 so that the image quality of an image of the application, the sound quality of a sound of the application, or the reproduction quality of the application can be better perceived by the user. In this case, such control of the user may be carried out immediately before or after executing the application, or may be carried out after a predetermined time has elapsed after executing the application. Therefore, when a user instructs a predetermined function to be implemented in relation to an application of interest, it is expected that the function will be implemented at least for a period before the execution point in time of the application and a period after the execution point in time of the application (where, the length of each period is not limited to a specific value). From this point of view, the period of the unit data 620 is set to identify the functions expected to be implemented in relation to the application.

At least as long as the period of the unit data 620 includes the execution point in time of the application of interest, the start and end points in time of each piece of the unit data 620 may be variously designed, but not necessarily designated in the same way as in this embodiment. In other words, the start point in time of the unit data 620 is designated as a predetermined point in time before the execution point in time of application, and the end point in time of the unit data 620 is designated as a predetermined point in time after the execution point in time of the application.

Each piece of the unit data 620 includes information about the execution of applications other than the first application of interest. For example, the unit data 620 corresponding to the first period may include information about the execution point in time of the second application. The unit data 620 corresponding to the second period may include information about a termination point in time of the second application and the execution point in time of the third application.

Below, a specific method of identifying the recommended functions based on the unit data 620 will be described in greater detail.

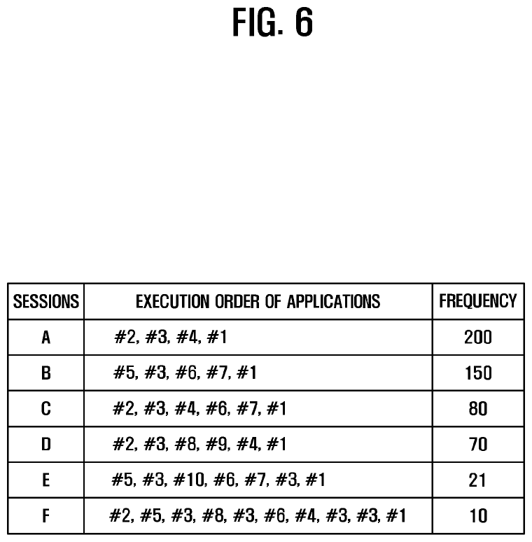

FIG. 6 is a diagram illustrating unit data sorted for each session according to usage patterns of a plurality of applications according to various embodiments.

As shown in FIGS. 1, 5 and 6, the electronic apparatus 1 acquires multiple pieces of unit data 620 with respect to an application of interest. Each piece of unit data 620 may include execution records for other applications #2 to #9, which are different from the application of interest, e.g., an application #1, in addition to the execution record for the application #1.

The electronic apparatus 1 classifies the multiple pieces of unit data 620 including the execution records for the application #1 of interest into a plurality of sessions according to the usage patterns of the plurality of applications. One session includes the unit data 620 that represents the same usage pattern of the plurality of applications, for example, the same execution order of the plurality of applications. For example, a session #A includes the unit data 620 that represents a usage pattern in which the applications are executed in order of #2, #3, #4, and #1. In other words, the session represents the usage pattern of the plurality of applications, and the frequency refers to the number of times the corresponding usage pattern appears in the acquired unit data 620. In this embodiment, the session #A has the highest frequency of usage pattern, and the frequency of the session #A is ‘200’. In this way, the electronic apparatus 1 may identify the frequencies of all the sessions.

When the session #A having the highest frequency is identified, the electronic apparatus 1 identifies the recommended functions based on the unit data 620 included in the identified session #A. For example, when the frequency of the session #A is overwhelmingly higher than those of other sessions (for example, when difference in frequency between the session #A and the next ranked session #B is greater than or equal to a predetermined threshold value or when the proportion of the frequency the session #A has in the sum of the frequencies all the sessions have is greater than or equal to a predetermined threshold value), only the session #A may be used in identifying the recommended functions.

To increase the reliability of identification, other sessions highly similar to the session #A having the highest frequency may be identified. Below, an embodiment of comparing the similarities between the plurality of sessions will be described.

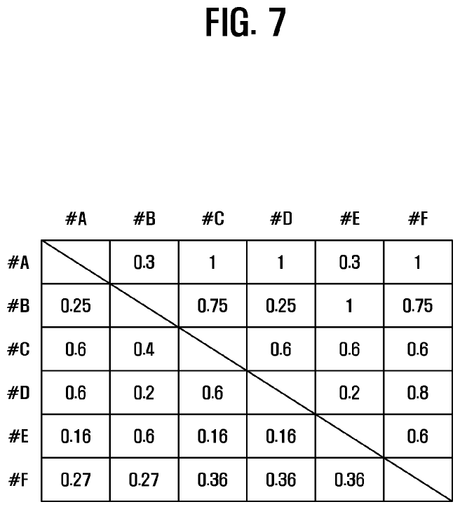

FIG. 7 is a diagram illustrating results from comparing similarities between a plurality of sessions according to various embodiments.

As shown in FIGS. 1, 5 and 7, the similarities between each session and the other sessions are calculated for all the sessions #A to #F. For example, the similarities between the session #A and the other sessions #B, #C, #D, #E and #F are calculated, and then the similarities between the next ranked session #B and the other sessions #A, #C, #D, #E and #F are calculated. The similarities are calculated in this way with respect to all the sessions may be tabulated as shown in Table of FIG. 7.

The similarities between the sessions may be calculated by various mathematical methods. For example, the electronic apparatus 1 may identify the similarities between orders of executing the plurality of applications in two respective sessions as the similarities between the sessions. However, this is merely an example, and various principles may be used in calculating the similarities according to design methods. The numerical values in FIG. 7 indicate the similarities, in which a low numerical value may refer, for example, to low similarity between two sessions and a high numerical value may refer, for example, to high similarity between two sessions. Here, the numerical values for the similarities shown in FIG. 7 are merely an example. For example, the session #A has high similarities to the sessions #C, #D and #F, and low similarities to the sessions #B and #E.

The electronic apparatus 1 identifies the sessions #C, #D and #F having high similarities to the session #A as a usage pattern group with respect to the session #A having the highest frequency, and acquires multiple pieces of unit data 620 included in the sessions #A, #C, #D and #F that belong to the identified usage pattern group. The sessions having high similarities to the session #A may be sessions of which the similarities are greater than or equal to a predetermined threshold value (e.g., 0.75). The electronic apparatus 1 identifies the recommended functions based on the acquired multiple pieces of unit data 620. A specific method of identifying the recommended functions will be described later.

When the similarities between the sessions are calculated, relationships between the sessions may be expressed on diagrams, examples of which are as follows.

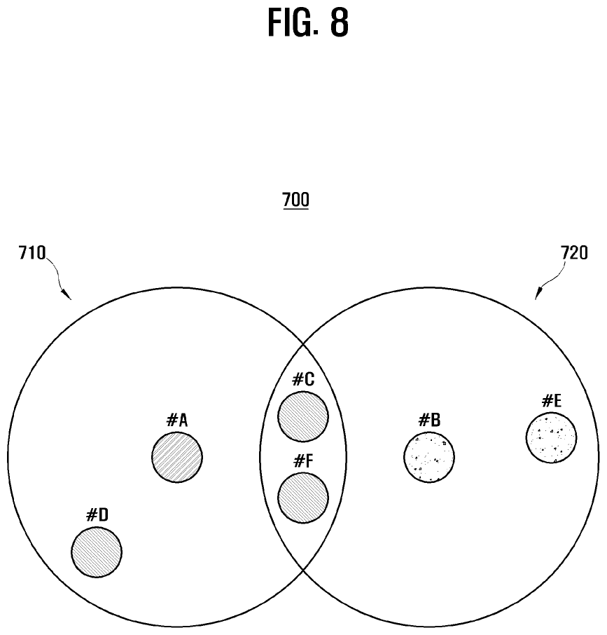

FIG. 8 is a diagram illustrating similarities between a plurality of sessions according to various embodiments.

As shown in FIGS. 1, 7 and 8, a plurality of sessions may be depicted as a diagram 700 on a plane based on the similarities. In the diagram 700, dots represent the sessions, and distances between two dots represent the similarities between two corresponding sessions. The closer the distance between two dots, the higher the similarities between two corresponding sessions. The farther the distance between two dots, the lower the similarities between two corresponding sessions. This diagram 700 is illustrated to represent the similarities between the sessions, in which the distances do not exactly correspond to the similarities.

When the session #A is used as a reference, the sessions #C, #D and #F having the similarities greater than or equal to the threshold value belong to the same first usage pattern group 710, and the sessions #B and #E having the similarities smaller than the threshold value do not belong to the first usage pattern group 710. On the other hand, the sessions #B, #C, #E and #F belong to a second usage pattern group 720 using the session #B as a reference. The sessions #C and #F belong to both the first usage pattern group 710 and the second usage pattern group 720 in common. In other words, which session belongs to which usage pattern group 710 or 720 depends on whether or not the similarity to the reference session is greater than or equal to the threshold value.

As described above, when the multiple pieces of unit data 620 that belong to the identified single session or the identified usage pattern group are identified, the electronic apparatus 1 identifies the recommended functions based on the acquired multiple pieces of unit data 620. The unit data 620 includes the execution records of the application, and the implementation records of the functions provided by the external devices 100, 200, and 300. The functions provided by the external devices 100, 200, and 300 refer to any functions that are supported by the processor 70 or the like hardware provided in the external devices 100, 200, and 300 or software or the like installed in the external devices 100, 200, and 300 and are controllable by a user. For example, the functions may include various kinds of functions the external device 100, 200, 300 may support, such as image quality modes (a normal mode, a movie mode, a reading mode, a late night mode, etc.) for an image displayed on the external devices 100, 200, and 300; sound field modes (selection of various setting preset options in an equalizer, selection of various sound field options, etc.) for a sound reproduced; and output modes (output to the internal loudspeakers of the external devices 100, 200 and 300, output to an external loudspeaker connected to the external devices 100, 200, and 300, etc.) for the sound reproduced; communication standards (HDMI, DisplayPort, Wi-Fi, Bluetooth, etc.) for transceiving data; and reproduction modes (a fast reproduction mode, a slow reproduction mode, a subtitle mode, etc.) related to the reproduction states of an image.

When the recommended functions are identified, the electronic apparatus 1 may transmit a guide for the recommended functions to the plurality of external devices 100, 200, and 300 in a lump without distinguishing between users. The electronic apparatus 1 may be designed to specify a user of one among the external device 100, 200 or 300, identify the recommended functions for the specified user, and transmit the identified recommended functions to the external device 100, 200 or 300 of the specified user. In this regard, descriptions will be made in greater detail below.

There may be various examples for the method of identifying the recommended functions. The electronic apparatus 1 may select the most frequently used function as the recommended function among a plurality of functions recorded in the acquired multiple pieces of unit data 620. For example, when the designated application is an application that provides a streaming image, and the function of switching an image quality mode of an image over to a movie mode has been most frequently used, the electronic apparatus 1 identifies the function of switching the image quality mode of the image over to the movie mode as the recommended function.

The electronic apparatus 1 may select a plurality of functions, each usage frequency of which is greater than a predetermined threshold value, as the recommended functions among a plurality of functions recorded in the acquired multiple pieces of unit data 620. For example, with respect to the application that provides the streaming image, when the frequency of using the function of switching the image quality mode of the image over to the movie mode is greater than the threshold value and the frequency of using the function of switching the output mode of the sound over to an external loudspeaker is greater than the threshold value, the electronic apparatus 1 identifies those two functions as the recommended functions.

The electronic apparatus 1 may identify the recommended functions based on a user's usage behavior data in the external devices 100, 200, and 300 specified to provide the recommended functions. Regarding this embodiment, descriptions will be made below.

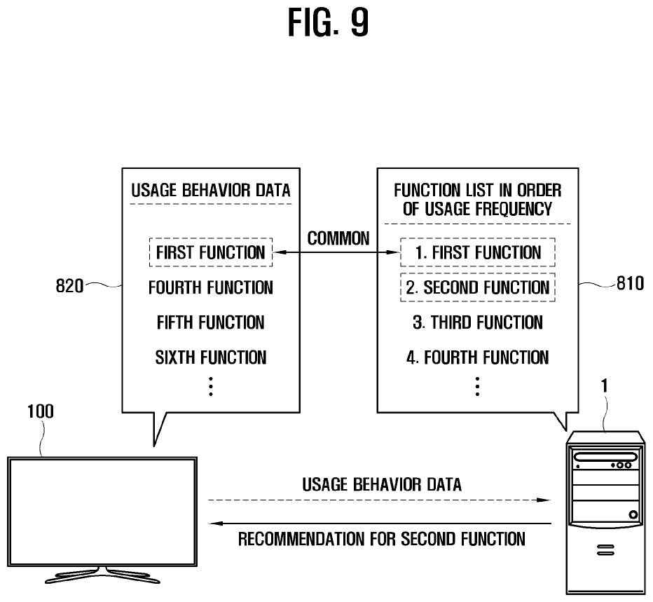

FIG. 9 is a diagram illustrating a principle that an electronic apparatus guides the recommended functions to a specific external apparatus according to various embodiments.

As shown in FIG. 9, for example, when a specific user of a specific external device 100 designates a certain application, the electronic apparatus 1 may make a function list 810 in which a plurality of identified functions are arranged in order of usage frequency based on the application designated by the user. The method of identifying the plurality of functions is the same as or similar to that described in the previous example. The function list 810 is illustrated to simply show the embodiment, and the electronic apparatus 1 is not limited to actually making such a list 810. For example, the function list 810 shows a first function, a second function, a third function, and a fourth function according to the order of usage frequency.

The electronic apparatus 1 may recommend one or more among the plurality of functions in the function list 810 to the user's external device 100. Here, there may be various recommended methods. As one example, the electronic apparatus 1 may transmit information about all the plurality of functions in the function list 810 to the external device 100. Alternatively, the electronic apparatus 1 may transmit information about N functions (where N is a natural number) having a higher usage frequency, e.g., the first function, the second function, and the third function (N=3 in this embodiment), among the plurality of functions in the function list 810 to the external device 100. Alternatively, the electronic apparatus 1 may transmit information about one function having the highest usage frequency, e.g., the first function, among the plurality of functions in the function list 810 to the external device 100.

Here, the electronic apparatus 1 compares the plurality of functions in the function list 810 with one or more functions recorded in the usage behavior data 820 acquired from the external device 100 of the specific user to identify whether there is an overlap between them. When the function having a high usage frequency in the function list 810 is that recorded in the usage behavior data 820 of the user (e.g., when that function is an overlapped function between the function list 810 and the usage behavior data 820), the electronic apparatus 1 excludes that function and identifies a function having the next high usage frequency as the recommended function. For example, when it is identified that the first function having the highest usage frequency in the function list 810 is present in the usage behavior data 820 of the external device 100, the electronic apparatus 1 identifies the second function, which has the next highest usage frequency after the first function in the function list 810 and is absent in the usage behavior data 820, as the recommended function (e.g., identifies a function that has not been already used by the user as the recommended function).

Below, an example of how the external device 100 guides the recommended function will be described in greater detail.

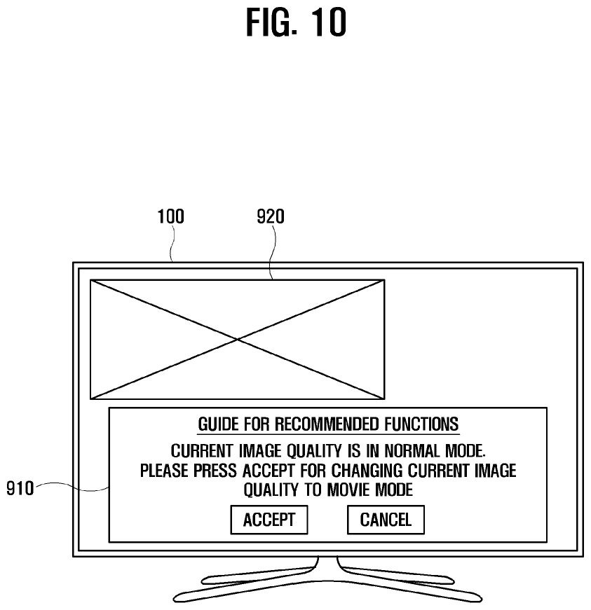

FIG. 10 is a diagram illustrating an example UI through which an external device guides the recommended function according to various embodiments.

As shown in FIGS. 9 and 10, the external device 100 receives information about the recommended function from the electronic apparatus 1 and displays a UI 910 that guides the recommended function based on the received information. The UI 910 provides a message for guiding the recommended function, and an option for setting the recommended function. The external device 100 may display the UI 910, when the received information is identified or when the application of interest in the previous embodiment is executed.

The external device 100 displays the UI 910 together with a running screen 920 of the application of interest while displaying the running screen 920 of the application. The external device 100 may display the UI 910 and the running screen 920 of the application without overlapping each other, or may display the UI 910 to be overlaid on the running screen 920 of the application.

Thus, when a user executes an application of interest, the external device 100 may guide the user through the functions useful for that application.

Below, an example operation sequence of the electronic apparatus 1 will be described in greater detail.

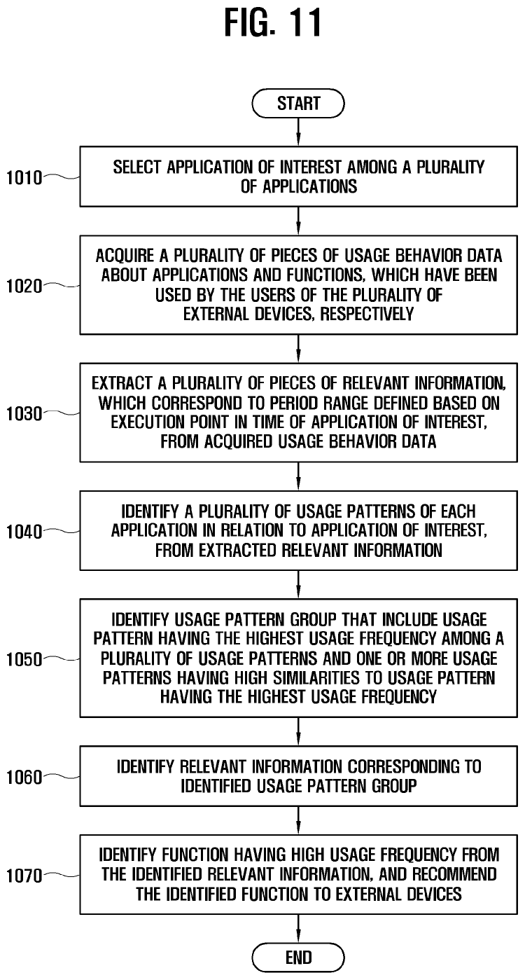

FIG. 11 is a flowchart illustrating an example of how an electronic apparatus identifies the recommended functions according to various embodiments.

As shown in FIGS. 1 and 11, the following operations may be performed by the processor 70 of the electronic apparatus 1.

At operation 1010 the electronic apparatus 1 selects an application of interest among a plurality of applications. The application of interest may also be selected by any of the electronic apparatus 1 or the external devices 100, 200, and 300.

At operation 1020 the electronic apparatus 1 acquires a plurality of pieces of usage behavior data about applications and functions, which have been used by the users of the plurality of external devices 100, 200, and 300, respectively. The electronic apparatus 1 acquires the usage behavior data from the external devices 100, 200, and 300 of the users who have agreed with the policy information described above.

At operation 1030 the electronic apparatus 1 extracts a plurality of pieces of relevant information, which corresponds to a period range defined based on an execution point in time of the application of interest, from the acquired usage behavior data. The relevant information may include execution records within a predetermined period of time, in which an execution point in time of the application of interest is included, among the execution records of the entire time period of the usage behavior data. Because the relevant information is extracted corresponding to the execution point in time of the application of interest, the number of pieces of relevant information corresponding to the number of times the application of interest has been executed may be generated from the usage behavior data.

At operation 1040 the electronic apparatus 1 identifies a plurality of usage patterns of each application in relation to the application of interest, from the extracted relevant information. For example, the usage pattern refers to a pattern in which other applications have been executed until the application of interest is last executed.

At operation 1050 the electronic apparatus 1 identifies a usage pattern group that includes a usage pattern having the highest usage frequency among a plurality of usage patterns, and one or more usage patterns having high similarities to the usage pattern having the highest usage frequency.

At operation 1060 the electronic apparatus 1 identifies the relevant information corresponding to the identified usage pattern group. The electronic apparatus 1 identifies the relevant information indicating the usage pattern included in the identified usage pattern group.

At operation 1070 the electronic apparatus 1 identifies a function having a high usage frequency from the identified relevant information, and recommends the identified function to the external devices 100, 200, and 300. The electronic apparatus 1 recommends one or more functions, which have a predetermined rank or higher, among the functions recorded in the identified relevant information, to the external devices 100, 200, and 300.

The operations of the apparatus described above in the foregoing example embodiments may be performed by artificial intelligence installed in the apparatus. The artificial intelligence may be applied to various systems based on machine learning algorithms. The artificial intelligence system refers to a computer system that implements human-level intelligence or near human-level intelligence, in which a machine, device or system autonomously learns and makes a decision, and a recognition rate and a decision accuracy are improved based on accumulated use experiences. Artificial intelligence technology is based on elementary technology by utilizing machine learning technology and algorithms using an algorithm of autonomously classifying/learning features of input data to copy perception, determination and the like functions of a human brain.

The elementary technology may for example include at least one of linguistic comprehension technology for recognizing a language/text of a human, visual understanding technology for recognizing an object like a human sense of vision, inference/prediction technology for identifying information and logically making inference and prediction, knowledge representation technology for processing experience information of a human into knowledge data, and motion control technology for controlling a vehicle's automatic driving or a robot's motion.

Here, the linguistic comprehension refers to technology of recognizing and applying and processing a human's language or character, and includes natural language processing, machine translation, conversation system, question and answer, speech recognition and synthesis, etc.

The inference/prediction refers to technology of identifying information and logically making prediction, and includes knowledge and possibility-based inference, optimized prediction, preference-based plan, recommendation, etc.

The knowledge representation refers to technology of automating a human's experience information into knowledge data, and includes knowledge building such as data creation and classification, knowledge management such as data utilization, etc.

The methods according to the foregoing embodiments may be achieved in the form of a program instruction that can be implemented in various computers, and recorded in a computer readable medium. Such a computer readable medium may include a program instruction, a data file, a data structure or the like, or combination thereof. For example, the computer readable medium may be stored in a nonvolatile storage unit such as universal serial bus (USB) memory, regardless of whether it is deletable or rewritable, for example, a RAM, a ROM, a flash memory, a memory chip, an integrated circuit (IC) or the like memory, or an optically or magnetically recordable or machine (e.g., a computer)-readable storage unit medium, for example, a compact disk (CD), a digital versatile disk (DVD), a magnetic disk, a magnetic tape or the like. It will be appreciated that a memory, which can be included in a mobile terminal, is an example of the machine-readable storage unit medium suitable for storing a program having instructions for realizing the various embodiments. The program instruction recorded in this storage unit medium may be specially designed and configured according to the various embodiments, or may be publicly known and available to those skilled in the art of computer software. Further, the computer program instruction may be implemented by a computer program product.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic apparatus comprising:
a communication circuit; and
at least one processor, comprising processing circuitry, individually and/or collectively configured to:
acquire usage behavior data about a plurality of applications executed in a plurality of external devices and a plurality of functions provided by each external device, from the plurality of external devices through the communication circuit,
acquire relevant information indicating one or more functions performed within a period range based on an execution point in time of the application among the plurality of functions, based on the acquired usage behavior data, and
perform a recommended operation of the one or more functions corresponding to an application executed in the external device, based on the acquired relevant information.

2. The electronic apparatus of claim 1, wherein at least one processor, individually and/or collectively, is configured to:
identify a function having a usage frequency greater than a specified threshold among the one or more functions indicated by the relevant information, and
perform the recommended operation of the function, identified as having the usage frequency greater than the specified threshold, for the designated external device.

3. The electronic apparatus of claim 2, wherein at least one processor, individually and/or collectively, is configured to perform the recommended operation of a function, which does not overlap with one or more functions indicated as having been used based on the usage behavior data of the designated external device, among the functions identified as having the usage frequency greater than the specified threshold.

4. The electronic apparatus of claim 2, wherein at least one processor, individually and/or collectively, is configured to:
identify a plurality of usage patterns of each application based on the acquired usage behavior data, and
identify a function corresponding to a usage pattern having a highest usage frequency among the plurality of identified usage patterns, as the at one or more functions to perform the recommended operation.

5. The electronic apparatus of claim 4, wherein at least one processor, individually and/or collectively, is configured to identify a function having a usage frequency greater than a threshold, from the usage behavior data indicating the usage pattern having the highest usage frequency, as the at least one function to perform the recommended operation.

6. The electronic apparatus of claim 4, wherein the plurality of usage patterns comprises a pattern of executing another application within the period range until the application designated for the recommended operation is executed.

7. The electronic apparatus of claim 4, wherein at least one processor, individually and/or collectively, is configured to:
identify a usage pattern group comprising one or more usage patterns having similarities greater than a specified threshold to the usage pattern having the highest usage frequency among the plurality of identified usage patterns, and
identify functions corresponding to the usage patterns in the identified usage pattern group, as the at least one function to perform the recommended operation.

8. The electronic apparatus of claim 7, wherein at least one processor, individually and/or collectively, is configured to identify a function having a usage frequency greater than a specified threshold in the usage behavior data indicating each usage pattern in the usage pattern, as the at least one function to perform the recommended operation.

9. The electronic apparatus of claim 6, wherein at least one processor, individually and/or collectively, is configured to identify the period range based on a period ranging from a first point in time, which is a specified point in time before the designated application is executed, to a second point in time when the designated application is terminated.

10. A method of controlling an electronic apparatus, comprising:
acquiring usage behavior data about a plurality of applications executed in a plurality of external devices of a user and a plurality of functions provided by each external device, from the plurality of external devices;
acquiring relevant information indicating one or more functions performed within a period range based on an execution point in time of the application among the plurality of functions, based on the acquired usage behavior data; and
performing a recommended operation of the one or more functions corresponding to an application executed in the external device, based on the acquired relevant information.

11. The method of claim 10, wherein the performing the recommended operation comprises:
identifying a function having a usage frequency greater than a specified threshold among the one or more functions indicated by the relevant information; and
performing the recommended operation of the function, identified as having the usage frequency greater than the specified threshold, for the external device designated.

12. The method of claim 11, wherein the performing the recommended operation comprises performing the recommended operation of a function, which does not overlap with one or more functions indicated as having been used based on the usage behavior data of the designated external device, among the functions identified as having the usage frequency greater than the specified threshold.

13. The method of claim 10, wherein the performing the recommended operation comprises:
identifying a plurality of usage patterns of each application based on the acquired usage behavior data; and
identifying a function corresponding to a usage pattern having the highest usage frequency among the plurality of identified usage patterns, as the at least one function to perform the recommended operation.

14. The method of claim 13, further comprising a function having a usage frequency greater than a specified threshold, from the usage behavior data indicating the usage pattern having the highest usage frequency, as the at least one function to perform the recommended operation.

15. The method of claim 13, wherein the plurality of usage patterns comprises a pattern of executing another application within the period range until the application designated for the recommended operation is executed.
